(19) United States
(12) Patent Application Publication
(10) Pub. No.: US 2026/0044475 A1
(43) Pub. Date: Feb. 12, 2026

(54) COMPUTER-READABLE RECORDING MEDIUM, CONVERSION METHOD, AND CONVERSION DEVICE

(71) Applicant: Fujitsu Limited, Kawasaki-shi (JP)

(72) Inventors: Toshihiro SHIMIZU, Sagamihara (JP); Hiroki TOKURA, Yokohama (JP)

(73) Assignee: Fujitsu Limited, Kawasaki-shi (JP)

(21) Appl. No.: 19/289,146

(22) Filed: Aug. 4, 2025

(30) Foreign Application Priority Data
Aug. 6, 2024 (JP) 2024-130184

(51) Int. Cl. G06F 15/82; G06F 9/30

(52) U.S. Cl. CPC G06F 15/825; G06F 9/3001

(57) ABSTRACT

A non-transitory computer-readable recording medium stores therein a conversion program that causes a computer to execute a process including, acquiring a predetermined original DFG and a mapping result of mapping of the predetermined original DFG with respect to a CGRA that includes a plurality of arithmetic operation units, extracting, from the predetermined original DFG, a portion corresponding to a pattern that is formed in the DFG and that has been determined in advance, determining a conversion candidate DFG based on a location in which the extraction portion has been allocated and based on the number of transmission paths for data used between the arithmetic operation units indicated in the mapping result, and generating a converted DFG based on the conversion candidate DFG by converting the predetermined original DFG.

### CROSS-REFERENCE TO RELATED APPLICATION

This application is based upon and claims the benefit of priority of the prior Japanese Patent Application No. 2024-130184, filed on Aug. 6, 2024, the entire contents of which are incorporated herein by reference.

### FIELD

The embodiment discussed herein is related to a computer-readable recording medium, a conversion method, and a conversion device.

### BACKGROUND

In recent years, as one of data processing devices, a coarse-grained reconfigurable architecture (CGRA) having excellent calculation performance and excellent energy efficiency for data processing has been drawing attention. The CGRA is a technology for a processor in which arithmetic operation units that are referred to as processing elements (PEs) each having an arithmetic operation unit, a register, and the like are arranged in a two-dimensional array. The CGRA is a reconfigurable architecture in which arithmetic operation content of arithmetic operations performed by PEs and a data transfer path between the PEs can be reconfigured in operation. In some cases, a processor itself in which the PEs are arranged in a two-dimensional array is referred to as a CGRA.

A program executed by using the CGRA is performed as described below. The program to be executed is converted to a data flow graph (DFG) by using a compiler. The DFG includes nodes, each of which indicates an arithmetic operation and directed edges, each of which indicates data dependency between the arithmetic operations. The directed edge indicates that output data of a transmission source node is used as input data of a transmission destination node. Then, the arithmetic operation content of the arithmetic operation performed by each of the PEs and routing line of data between the PEs are determined based on the DFG in accordance with the configuration of each of the PEs included in the CGRA. The determination of both arithmetic operation content of the arithmetic operations and the routing line of the data between the PEs are referred to as mapping. After that, data is input to the CGRA in which the mapping has been completed, and then, the CGRA performs an arithmetic operation by using the input data.

Furthermore, as a technology for a mapping, there is a proposed technology for allocating, regarding the governing equations of the field described by the equation, lattice points obtained by spatially dividing the field to each element processors and solving a partial differential equation by asynchronously and independently operating the element processors.
Patent Document 1: Japanese Laid-open Patent Publication No. 08-087475

However, in some DFGs, mapping may be performed with inefficient use of the PE, so that it is difficult to increase the number of arithmetic operations performed by using the CGRA, and, there may be a case in which it is difficult to improve the processing capacity. For example, in a case where data with an amount of data that can be transmitted between the PEs is transmitted, a PE that passes the data without performing the arithmetic operation is generated, and thus, the number of PEs that are used for the arithmetic operation is reduced.

Furthermore, in a case where the flow of the data is limited to a one-way direction, by reducing the number of columns to be mapped in the one-way direction, it is easy to perform expansion by combination, and throughput enhancement is accordingly expected; therefore, it is preferable to be able to perform mapping with a smaller number of columns. However, in some DFGs, the number of columns in the one-way direction consequently increases, and thus, it is difficult to perform expansion by combination and it is thus difficult to improve the processing capacity.

### SUMMARY

According to an aspect of an embodiment, a non-transitory computer-readable recording medium stores therein a conversion program that causes a computer to execute a process including, acquiring a predetermined original data flow graph (DFG) and a result of mapping of the DFG to a coarse-grained reconfigurable architecture (CGRA) that includes a plurality of arithmetic operation units, the mapping result including information that is related to allocation of an arithmetic operation to each of the arithmetic operation units and is related to a routing line between the arithmetic operation units and that has been determined so as to correspond to the predetermined original DFG, extracting, from the predetermined original DFG, a portion corresponding to a pattern that is formed in the DFG and that has been determined in advance, determining a conversion candidate DFG that is included in the DFG corresponding to the pattern of an extraction portion based on a location in which the extraction portion has been allocated and that is indicated in the mapping result and based on the number of transmission paths for data used between the arithmetic operation units indicated in the mapping result, and generating a converted DFG based on the conversion candidate DFG by converting the predetermined original DFG.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an automatic mapping system according to an embodiment;

FIG. 2 is a diagram illustrating information on an architecture designed for a CGRA according to the embodiment;

FIG. 3 is a block diagram illustrating a DFG conversion device;

FIG. 4 is a diagram illustrating a first pattern of the DFG corresponding to a conversion candidate;

FIG. 5 is a diagram illustrating the DFG that is after conversion obtained by converting the DFG formed in a first pattern;

FIG. 6 is a diagram illustrating one example of conversion of the DFG including the DFG formed in the first pattern;

FIG. 7 is a diagram illustrating a second pattern of the DFG corresponding to the conversion candidate;

FIG. 8 is a diagram illustrating the DFG that is after conversion obtained by converting the DFG formed in the second pattern;

FIG. 9 is a diagram illustrating one example of the DFG including the DFG formed in the second pattern;

FIG. 10 is a diagram illustrating one example of the DFG obtained by converting the DFG formed in the second pattern;

FIG. 11 is a diagram illustrating a third pattern of the DFG corresponding to the conversion candidate;

FIG. 12 is a diagram illustrating the DFG that is after conversion obtained by converting the DFG formed in the third pattern;

FIG. 13A is a diagram illustrating an application example of the conversion of the DFG;

FIG. 13B is a diagram illustrating an application example of the conversion of the DFG;

FIG. 14 is a flowchart of a generation process of generating a DFG conversion candidate;

FIG. 15 is a flowchart of an extraction process of extracting a portion of the DFG formed in the first pattern;

FIG. 16 is a flowchart of an extraction process of extracting a portion of the DFG formed in the second pattern;

FIG. 17 is a flowchart of an extraction process of extracting a portion of the DFG formed in the third pattern;

FIG. 18 is a flowchart of a DFG candidate determination process and the generation process of generating the converted DFG;

FIG. 19 is a flowchart of the conversion process of converting the DFG formed in the first pattern;

FIG. 20 is a flowchart of is the conversion process of converting the DFG formed in the second pattern;

FIG. 21 is a flowchart of the conversion process of converting the DFG formed in the third pattern; and

FIG. 22 is a diagram illustrating a hardware configuration of the DFG conversion device.

### DESCRIPTION OF EMBODIMENTS

Preferred embodiments of the present invention will be explained with reference to accompanying drawings. Furthermore, the conversion program, the conversion method, and the conversion device disclosed in the present application are not limited to the embodiments.

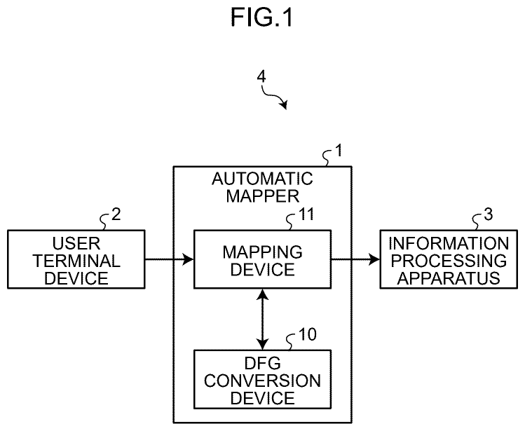

FIG. 1 is a block diagram illustrating an automatic mapping system according to an embodiment. An automatic mapping system 4 according to the present embodiment includes an automatic mapper 1, a user terminal device 2, and an information processing apparatus 3. The automatic mapper 1 is connected to the user terminal device 2 and the information processing apparatus 3.

The information processing apparatus 3 is a computer on which a CGRA is mounted. The information processing apparatus 3 performs a process conforming to a predetermined use purpose as a result of a data flow graph (DFG) being mapped into the CGRA. The DFG has been designed in accordance with the predetermined purpose of use. The CGRA includes a plurality of PEs that are arithmetic operation units. The PEs are arranged in two-dimensional array.

The user designs a DFG for operating the CGRA. The DFG is a diagram that indicates both of the flow of data and arithmetic operations to be performed in a system that causes a calculation to be performed. Here, the subject to be performed by the DFG as a whole is referred to as a “calculation”, and a plurality of “arithmetic operations” are included in the “calculation”. In addition, hereinafter, a part of DFG that is included in a certain DFG is sometimes referred to as a partial DFG.

The user terminal device 2 is a terminal device that is used by a user who uses the information processing apparatus 3 having therein installed the CGRA. The user terminal device 2 transmits the DFG that has been designated by the user to the automatic mapper 1, and causes the automatic mapper 1 to perform mapping into the CGRA that is installed in the information processing apparatus 3.

the automatic mapper 1 maps the DFG that has been designated by the user into the CGRA. The mapping mentioned here is a process of allocating an arithmetic operation defined in the DFG to any one of the PEs that are included in the CGRA, deciding a connection between the PEs such that each of the arithmetic operations that have been defined in the DFG is performed in accordance with the data flow, and constituting the CGRA so as to be able to perform a calculation indicated in the DFG.

A mapping device 11 includes in advance information on the architecture of the CGRA installed in the information processing apparatus. In the information on the architecture of the CGRA, the number of PEs held by the CGRA, the number of routing lines between the respective PEs, connection information on the connection between each of the PES, and the like are included. The mapping device 11 acquires the DFG that has been transmitted from the user terminal device 2.

Then, the mapping device 11 maps the acquired DFG into the CGRA that has been installed in the information processing apparatus 3 in accordance with an optimum algorithm that has been given in advance. Then, the mapping device 11 outputs the mapping result to a DFG conversion device 10 together with the DFG that has been designated by the user. The mapping result is the information that indicates allocation of an arithmetic operation to each of the PEs and the routing line between each of the PEs corresponding to the plurality of arithmetic operation units that have been determined so as to corresponds to the DFG.

After that, the mapping device 11 receives, from the DFG conversion device 10 based on the output mapping result, an input of a converted DFG that has been converted such that a transmission column of the data in the DFG given by the user is reduced. Then, the mapping device 11 performs the mapping again by using the converted DFG. After that, the mapping device 11 outputs the mapping result to the information processing apparatus 3, and causes the information processing apparatus 3 to perform actual mapping with respect to the CGRA in accordance with the mapping result.

The DFG conversion device 10 receives the mapping result and an input of the DFG that has been given by the user from the mapping device 11. The DFG that has been given by the user corresponds to one example of a “predetermined original DFG”. Furthermore, the DFG conversion device 10 holds in advance the information on the architecture of the CGRA installed in the information processing apparatus 3.

Then, the DFG conversion device 10 uses the DFG, the mapping result, and the information on the architecture of the CGRA, and generates a DFG conversion candidate for reducing the number of transmission columns of the data of the given DFG. The DFG conversion candidate mentioned here is a partial DFG of the given DFG, and is a partial DFG in which mapping is able to be performed with a smaller number of transmission columns of the data than that indicated in the mapping result by converting to another configuration.

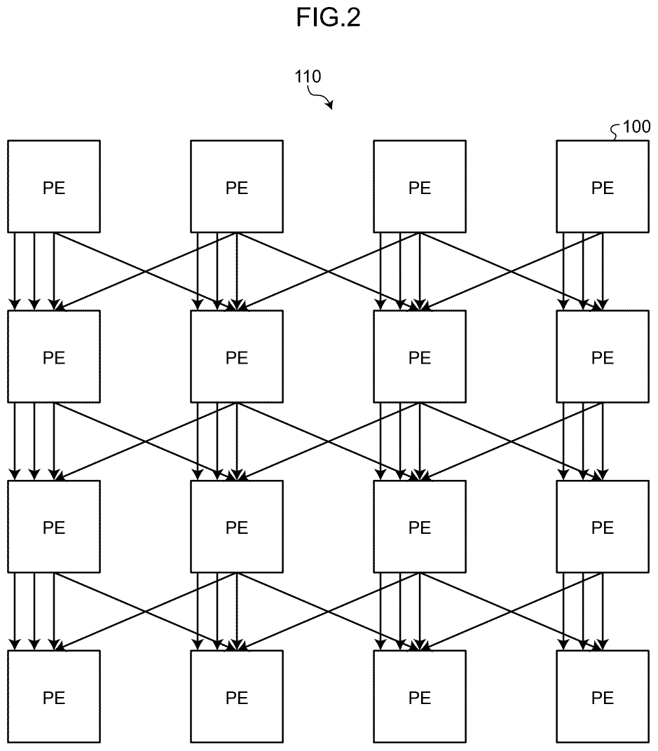

In the following, the transmission column of the data will be described. FIG. 2 is a diagram illustrating information on the architecture of the CGRA according to the embodiment. Here, the vertical direction in the plane of the drawing illustrated in FIG. 2 is referred to as a column, and the horizontal direction in the plane of the drawing illustrated in FIG. 2 is referred to as a row. Furthermore, the description below will be given by using the up, down, left, and right directions in the plane of the drawing illustrated in FIG. 2.

FIG. 2 illustrates 16 PEs 100 that are part of a CGRA 110 and that are arranged in a matrix with four 4 rows and four columns. In FIG. 2, a connection to the PEs 100 that are arranged further to the right side than the PE 100 that is arranged on the rightmost side and a connection from the PEs 100 that are arranged further to the left side than the PE 100 that is arranged on the leftmost side are omitted. Furthermore, in FIG. 2, a connection to the PEs 100 that are arranged further below than the PE 100 that is arranged at the lower end and a connection to the PEs 100 that are arranged above than the PE 100 that is arranged at the upper end are omitted.

The PE 100 forms a two-dimensional array using each of the column directions and the row direction as two dimensions. The PE 100 is connected to the PE 100 that is located directly below in the column direction by three routing lines. Furthermore, the PE 100 is connected to each of the PEs 100 that is located one row below and the next column. However, one of the routing lines that is connected to the PE 100 located directly below and the routing lines that are connected to each of the PEs 100 located on the lower left side and the lower right side are routing lines each of which outputs a single output of value. In other words, the PE 100 is able to output, by using the above described routing lines, the same data to the PE 100 that is located on one of the lower left side and the lower right side or that is located at a combination thereof. In other words, the maximum number of types of output values that are able to be simultaneously output by the PEs 100 located on except for the rightmost, the leftmost, and the lower end sides included in the entire CGRA 110 is three.

Here, FIG. 2 illustrates a part of the CGRA 110, but an input to the PE 100 that is located on the top included in the entire CGRA 110 is connected to an input node that inputs data. Furthermore, the PE 100 located on the rightmost side included in the entire CGRA 110 does not have a connection from the PE 100 that is located on the upper right side, and the PE 100 located on the leftmost side does not have a connection from the PE 100 that is located on the upper left side. Furthermore, the PE 100 that is located on the lower end side included in the entire CGRA 110 is not connected to the other PEs 100, and outputs data of the calculation result. In this way, each of the PEs 100 other than the PE 100 that is located at the end portion includes input ports that receive inputs of five different types of input values, and also include output ports that output three different types of output values.

In addition, between the PEs 100 according to the present embodiment, data flows in one direction of the column. In other words, in FIG. 2, the data flows from the upper part toward the lower part in the column direction. At this time, the data freely moves in the row direction. In FIG. 2, the data is able to flow from one of the PEs 100 to the PE 100 that is located directly below the subject PE 100, to the PE 100 that is located on the lower right side of the subject PE 100, and to the PE 100 that is located on the lower left side of the subject PE 100.

Here, the path for transmitting a single piece of data in the PEs 100 that are arranged in the column direction illustrated in FIG. 2 corresponds to a transmission column for transmitting the data. In other words, in FIG. 2, each of the PEs 100 arranged in the column direction includes three transmission columns for transmitting the data. A process of reducing the number of transmission columns for transmitting the data indicates a process or reducing the number of transmission paths for the data in the column direction that is used to flow the data at a certain timing. In the description below, the arrangement of the PEs 100 in the flow direction of the data in the two-dimensional array is referred to as a column, and the arrangement of the PEs 100 in the dimension that is other than the column is referred to as a row.

A description will be given here by referring back to FIG. 1. The DFG conversion device 10 select an application DFG that is used to perform conversion from among the generated DFG conversion candidates, and generates a converted DFG by converting the DFG that has been given by the application DFG. Then, the DFG conversion device 10 transmits the generated converted DFG to the mapping device 11, and instructs the mapping device 11 to perform the mapping by using the transmitted converted DFG.

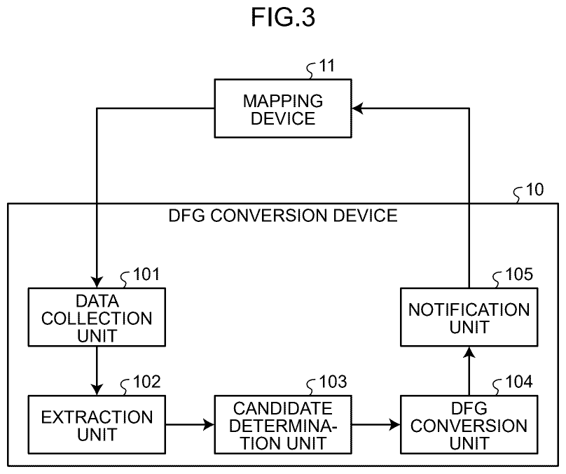

In the following, the DFG conversion device 10 will be described in detail. FIG. 3 is a block diagram illustrating the DFG conversion device. As illustrated in FIG. 3, the DFG conversion device 10 includes a data collection unit 101, an extraction unit 102, a candidate determination unit 103, a DFG conversion unit 104, and a notification unit 105.

The data collection unit 101 receives the mapping result and an input of the DFG that has been given by the user from the mapping device 11. Then, the data collection unit 101 outputs the mapping result and the DFG that has been given by the user to the extraction unit 102.

The extraction unit 102 receives the mapping result and an input of the DFG that has been given by the user from the data collection unit 101. The extraction unit 102 includes in advance a plurality of types of the patterns of the DFG corresponding to the conversion candidates. In the present embodiment, the extraction unit 102 has three types of patterns.

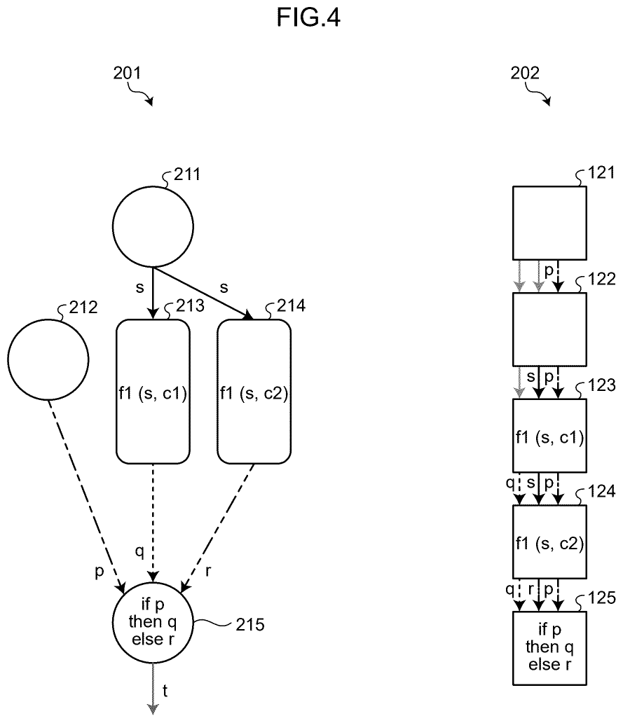

In the following, the three patterns of the DFG that can be candidates for the conversion candidate DFG. FIG. 4 is a diagram illustrating a first pattern of the DFG that is a candidate for the conversion candidate. In FIG. 4, a DFG 201 formed in the first pattern and a mapping result 202 obtained from the DFG 201 are illustrated.

Here, in the DFG 201, the circular shape represents a single node. Furthermore, the rectangular shape with rounded corners represents a partial DFG included in the DFG 201. The partial DFG may be a single node, or may include a plurality of nodes and branches that connect the plurality of nodes. The mapping to be performed with respect to the partial DFG does not receive a change, so that, it is conceivable that the partial DFG is a single node. One of the PEs 100 is allocated to each of the nodes based on the mapping. Furthermore, the symbol indicated in the vicinity of the connection path between the nodes is an output value that is output from the connection source, and indicates a value that is to be input to the connection destination.

For example, the DFG 201 includes a node 211, a node 212, a partial DFG 213, a partial DFG 214, and a node 215. The node 211 outputs s as the output value of the arithmetic operation result to each of the partial DFGs 213 and 214. Furthermore, the partial DFG 213 uses s that is the output value output from the node 211 and performs an arithmetic operation of a function f1 (s, c1). Furthermore, the partial DFG 214 uses s that is the output value output from the node 211 and performs an arithmetic operation of a function f1 (s, c2). Here, c1 is a constant, and is a value that is held by the partial DFG 213. Furthermore, c2 is a constant, and is a value that is held by the partial DFG 214. In other words, both of the partial DFG 213 and the partial DFG 214 performs the arithmetic operation of the same function f1 except that an argument is a constant.

The partial DFG 213 q to the node 215 as an output value based on the arithmetic operation result. Furthermore, the partial DFG 214 outputs r as an output value based on the arithmetic operation result.

Furthermore, the node 212 outputs p to the node 215 as an output value. in a case where p satisfies a predetermined condition based on p that is the output value output from the node 212 as a branch condition, the node 215 regards q that is the output value output from the partial DFG 213 as an arithmetic operation result. Furthermore, in a case where p that is the output value output from the node 212 does not satisfy the predetermined condition, the node 215 regards r that is the output value output from the partial DFG 214 as an arithmetic operation result. The arithmetic operation performed by the node 215 is referred to as a predication. The node 215 outputs t as an output value based on the arithmetic operation result.

The DFG 201 is mapped as indicated by the mapping result 202. In the mapping result 202, PEs 121 to 125 that are five PEs 100 are used. In this case, the node 211 is allocated to the PE 121, the node 212 is allocated to the PE 122, the partial DFG 213 is allocated to the PE 123, the partial DFG 214 is allocated to the PE 124, and the node 215 is allocated to the PE 125. In the mapping result 202, the same data is transmitted by using the line with the same type as that of the line that indicates the flow of the data and that has been used in the DFG 201.

Furthermore, the line indicated in gray is a path through which arbitrary data is allowed to pass. In other words, in a case of the mapping result 202, three transmission columns are used to transmit the data at the same time at a maximum for the data transmission.

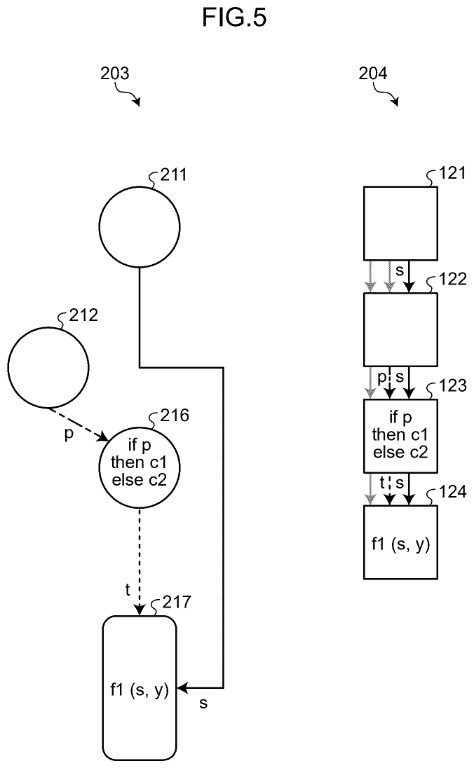

FIG. 5 is a diagram illustrating the DFG indicating after conversion obtained by converting the DFG that is formed in the first pattern. The DFG 201 is able to be replaced with a DFG 203. A node 216 performs an arithmetic operation in which the values of then and else indicated in the predication in the node 215 is replaced with c1 and c2, respectively, that are the constants used by the respective partial DFGs 213 and 214. The output value output from the node 212 is input to the node 216. Furthermore, a partial DFG 217 performs an arithmetic operation in which a portion of the constant has been changed to a variable included in the arithmetic operation performed by each of the partial DFGs 213 and 214. The partial DFG 217 uses the output value that is output from the node 211 and the output value that is output from the node 216 as an argument. In this case, the partial DFG 217 uses the output value output from the node 216 instead of using a constant in the arithmetic operation that is performed by each of the partial DFGs 213 and 214.

To make generalization, a condition for the DFG that is formed in the first pattern is the following condition. A node that performs the predication is present, and, in each of the partial DFGs that performs an arithmetic operation of a value of a case of then and a value of a case of else indicated in the subject predication, the nodes each of which outputs the output value that is used as an argument are the same.

Furthermore, the arithmetic operation performed by each of the partial DFGs is the same except for the constant portion. In other words, in the DFG 201, in a case where the node 211 is denoted by a first node, the node 212 is denoted by a second node, the partial DFG 213 is denoted by a third node, the partial DFG 214 is denoted by a fourth node, and the node 215 is denoted by a fifth node, the first pattern is able to be represented as follows. The first pattern includes the first node and the second node. Furthermore, the first pattern includes the third node and the fourth node each of which performs an arithmetic operation of a first function by using two arguments, that is, one of the two arguments is a fixed value, and the other of the two arguments is an output value output from the first node. The first function corresponds to the function f1 of the arithmetic operation performed by the partial DFGs 213 and 214 described above. In addition, the first pattern includes the fifth node that uses, as an output value, one of the output value output from the third node and the output value output from the fourth node in accordance with the determination result obtained by using the output value output from the second node as a determination condition.

The DFG that has been formed in the first pattern and that satisfies the above described condition is able to be converted as described below. It is assumed that each of a value at the time of then in the node that performs a predication and a value at the time of else in the node that performs the predication are set to be a constant that is used for the arithmetic operation performed in the two partial DFGs that are formed in the first pattern. Then, it is assumed that an input to the node that performs the predication is the same input as that used in a case of the partial DFG formed in the first pattern. Furthermore, one of the two partial DFGs is deleted, and the constant in the arithmetic operation performed by the other of the remaining partial DFG is replaced with a variable that takes an output value received from the node that performs the predication as an argument. In addition, it is assumed that an argument in the subject partial DFG is set to be an output value output from the node that is regarded as an argument by the partial DFG in the DFG formed in the first pattern and an output value output from the node that performs the predication. This conversion corresponds to conversion of “if p f1 (x, c1) else f1 (x, c2)” to “f1 (x, if p then c1 else c2)”.

After having performed this conversion, for example, the DFG 203 that has been obtained after conversion is mapped as indicated by a mapping result 204. In the mapping result 204, the PEs 121 to 124 that are the four PEs 100 are used. In this case, the node 211 is allocated to the PE 121, the node 212 is allocated to the PE 122, the node 216 is allocated to the PE 123, and a partial DFG 217 is allocated to the PE 124. In the mapping result 204, the same data is transmitted by using the line with the same type as that of the line that indicates the flow of the data and that has been used in the DFG 203. Furthermore, the line indicated in gray is a path through which arbitrary data is allowed to pass. In other words, in a case of the mapping result 204, two transmission columns are used to transmit the data at the same time at a maximum for the data transmission.

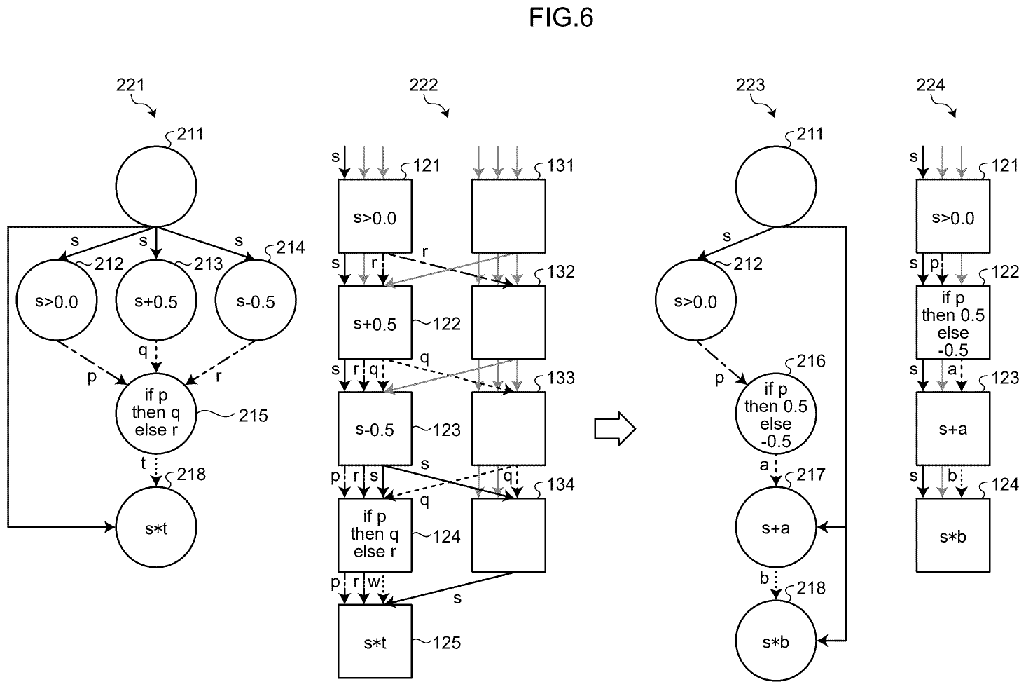

In the mapping result 204, as compared with the mapping result 202 illustrated in FIG. 4, it is possible to reduce a single transmission column for the data. In other words, it is possible to flow the data included in another DFG through the transmission column that has been used for the reduced piece of data, and as a whole, it is possible to improve the utilization efficiency of the PEs 100. In the following, the effect of the reduction in the transmission column used for the data obtained as a result of the conversion of the DFG formed in the first pattern will be described in detail. FIG. 6 is a diagram illustrating one example of conversion of the DFG including the DFG that has been formed in the first pattern.

For example, a description will be given in a case where a DFG 221 illustrated in FIG. 6 is converted. The DFG 221 is a DFG obtained by adding a node 218 that performs an arithmetic operation of s*t by using an output value of s output from the node 211 and an output value of t output from the DFG 201 as an argument to the DFG 201 that is the DFG formed in the first pattern illustrated in FIG. 4.

The DFG 221 is mapped as indicated by a mapping result 222. In the mapping result 222, the PEs 121 to 125 and 131 to 134 that are the eight PEs 100 are used. In the mapping result 222, three output values are used in the arithmetic operation performed in the PE 124. Furthermore, the PE 125 performs an arithmetic operation by using an output value of s output from the node 211 as an argument. In this case, at the time of a start of the arithmetic operation performed in the PE 124, a total of four pieces of data are consequently held. Accordingly, at the time of an input of data to the PE 124, a single transmission column for data is increased, in addition to the transmission column for the different pieces of data that have three types and that are able to be transmitted by the PE 124. As a result of this, the two columns of the two PEs 100 corresponding to the column of the PEs 121 to 125 and the column of the PEs 131 to 134 are used.

Accordingly, by converting the DFG that has been formed in the first pattern included in the DFG 221, a DFG 223 is generated. The DFG 223 is mapped as indicated by a mapping result 224. In the mapping result 224, the PEs 121 to 124 that are the four PEs 100 are used. The DFG that is formed in the first pattern and that has been obtained after conversion includes a maximum of two data transmission columns that are used at the same time, and a single piece of data transmission column remains from among the three data transmission columns that connect the PEs 121 to 124. Accordingly, it is possible to transmit, by using the remaining data transmission column, the data that is used for the arithmetic operation performed in the node 218 to the PE 125. As a result of this, as indicated in the mapping result 224, it is possible to limit the target for the mapping to the PEs 121 to 124 to the single piece of column used by the PE 100. In this case, the column used by the PE 100 including the PEs 131 to 134 that are to be used for the mapping performed in the original DFG 221 is able to be freely used by the mapping to be performed in the other DFG.

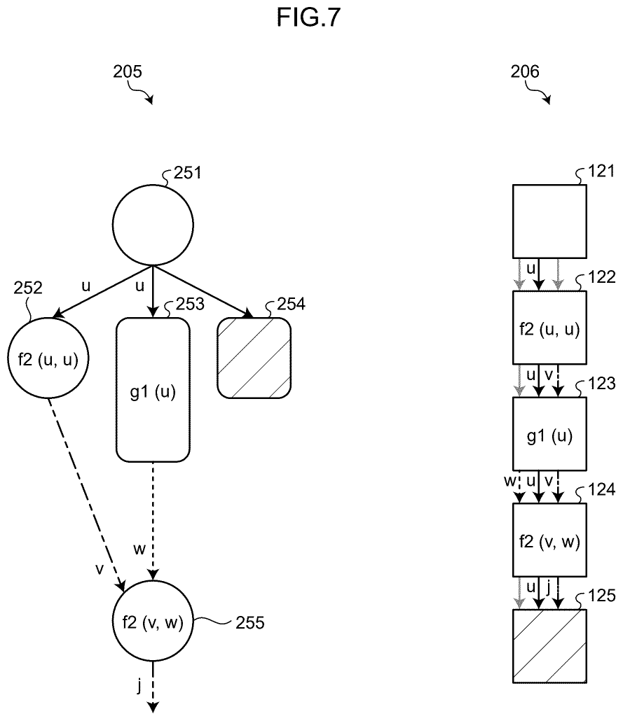

FIG. 7 is a diagram illustrating a second pattern of the DFG that is a candidate for a conversion candidate. In FIG. 7, a DFG 205 formed in the second pattern and a mapping result 206 obtained from the DFG 205 are illustrated.

For example, the DFG 205 includes a node 251, a node 252, a partial DFG 253, a partial DFG 254, and a node 255. The node 251 outputs, as an output value of the arithmetic operation result, u to the node 252 and the partial DFG 253. Furthermore, the node 251 outputs an output value to the partial DFG 254. The node 252 uses u that is the output value output from the node 251, performs an arithmetic operation of function f2 (u, u) that uses the same variables as two arguments, and outputs v as the output value based on the arithmetic operation result to the node 255. Here, f2 (x, y) satisfies the associative law represented by f2 (f2 (x, y), z)=f2 (x, f2 (y, z)). For example, f2 (x, y) is x×y, x+y, x & y, or the like.

Furthermore, the partial DFG 253 performs an arithmetic operation of g1 (u) by using u that is an output value output from the node 251, and outputs w as an output value based on the arithmetic operation result to the node 255. The node 255 performs the arithmetic operation that is indicated by f2 (v, w), that uses two different variables as arguments, and that is the same arithmetic operation as that performed by the node 211. The partial DFG 254 uses the output value received from the node 211 and performs a predetermined arithmetic operation.

The DFG 205 is mapped as indicated by the mapping result 206. Here, mapping has been performed such that the arithmetic operation to be performed by the partial DFG 254 is performed last. In the mapping result 206, the PEs 121 to 125 that are the five PEs 100 are used. In this case, the node 251 is allocated to the PE 121, the node 252 is allocated to the PE 122, the partial DFG 253 is allocated to the PE 123, the node 255 is allocated to the PE 124, and the partial DFG 254 is allocated to the PE 125. The partial DFG 254 is mapped after the PE 125 that is indicated in the same pattern.

In the mapping result 206, the same data is transmitted by using the line with the same type as that of the line that indicates the flow of the data and that has been used in the DFG 205. Furthermore, the line indicated in gray is a path through which arbitrary data is allowed to pass. In other words, in a case of the mapping result 206, the number of use of the data transmission columns between the PE 123 and the PE 124 becomes the maximum, and three transmission columns are used to transmit the data at the same time at a maximum for the data transmission.

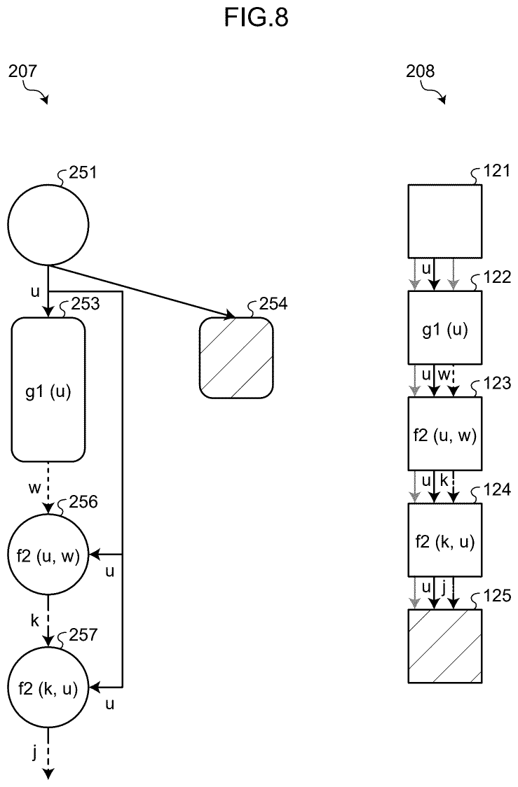

FIG. 8 is a diagram illustrating the DFG indicating after conversion obtained by converting the DFG formed in the second pattern. The DFG 205 is able to be replaced with a DFG 207. Each of the partial DFGs 253 and 254 receives an input of the output value output from the node 251, similarly to the DFG 205. The partial DFG 253 in FIG. 8 performs an arithmetic operation of g1 (u) that is the same as that performed by the partial DFG 253 in FIG. 7, and outputs w as an output value based on the arithmetic operation result. A node 256 uses u that is the output value output from the node 251 and w that is the output value output from the partial DFG 253, performs an arithmetic operation of a function f2 (u, w), and outputs k as the output value based on the arithmetic operation result. A node 257 performs an arithmetic operation of a function f2 (k, u) by using u that is the output value output from the node 251 and k that is an output value output from the node 256.

To make generalization, a condition for the DFG that is formed in the second pattern is the following condition. A node that performs an arithmetic operation of f2 (x, y) that satisfies the associative law by using the output value output from the starting point node as an argument is present, and also, it is assumed that each of the two variables that are used for the arithmetic operation by the node that performs the arithmetic operation of f2 (x, y) uses the output value output from a specific node as an argument. In other words, the node that performs the arithmetic operation of f2 (x, y) performs the arithmetic operation of f2 (x, x). Furthermore, the arithmetic operation result obtained by the node that performs the arithmetic operation of f2 (x, y) becomes an argument of the other node that performs the same arithmetic operation of f2 (x, y). Furthermore, the other node that performs the arithmetic operation of f2 (x, y) uses, as another argument, an output value output from the first partial DFG that performs an arithmetic operation by using an output value output from the starting point node as an argument. Furthermore, the output value output from the starting point node is input to the second partial DFG that is different from the first partial DFG.

In other words, in the DFG 205, in a case where the node 251 is denoted by the first node, the node 252 is denoted by the second node, the partial DFG 253 is denoted by the third node, the partial DFG 254 is denoted by the fourth node, and the node 255 is denoted by the fifth node, the second pattern is able to be represented as follows. The second pattern includes the first node. Furthermore, the second pattern includes the second node that performs an arithmetic operation of the second function that satisfies the associative law and that uses the two arguments by using the output value output from the first node as the two arguments. Furthermore, the second pattern includes the third node that performs an arithmetic operation by using the output value output from the first node as an argument. Furthermore, the second pattern includes the fourth node that performs an arithmetic operation of the second function by using the output value output from the second node and the output value output from the third node as two arguments. In addition, the second pattern includes the fifth node that receives an input of the output value output from the first node.

The DFG that has been formed in the second pattern and that satisfies the above described condition is able to be converted as described below. The two nodes each of which performs the arithmetic operation of f2 (x, y) are deleted. A first additional node that performs the arithmetic operation of f (x, y) by using the output values output from the first partial DFG and the starting point node as arguments is added. Then, a second additional node that performs the arithmetic operation of f (x, y) by using the output value output from the first additional node and the output value output from the starting point node is added. This conversion corresponds to conversion of “f2 (f2 (x, x), g (x))” to “f2 (x, f2 (x, g (x)))”. In addition, if f2 (x, y) is able to be converted, the same also applies to a case in which the function targeted for the conversion is “f2 (g (x), f2 (x, x))”.

In a case where this conversion has been performed, for example, the DFG 207 obtained after conversion is mapped as indicated by a mapping result 208. In the mapping result 208, the PEs 121 to 125 that are the five PEs 100 are used. In this case, the node 251 is allocated to the PE 121, the partial DFG 253 is allocated to the PE 122, the node 256 is allocated to the PE 123, the node 257 is allocated to the PE 124, and node that is located subsequent to the node 257 is allocated to the PE 125. In FIG. 8, the nodes that are located subsequent to the node 257 are not illustrated, the node that is allocated to the PE 125 is not directly illustrated. Furthermore, the partial DFG 254 is mapped after the PE 125 that is indicated by using the same pattern. In the mapping result 208, the same data is transmitted by using the line with the same type as that of the line that indicates the flow of the data and that has been used in the DFG 207. Furthermore, the line indicated in gray is a path through which arbitrary data is allowed to pass. In other words, in a case of the mapping result 208, two transmission columns for transmitting the data are used. In the mapping result 208, as compared with the mapping result 206 illustrated in FIG. 7, it is possible to reduce a single piece of the transmission column that is used to transmit the data. In other words, it is possible to flow the data included in another DFG through the transmission column that has been used for the reduced piece of data, and as a whole, it is possible to improve the utilization efficiency of the PEs 100.

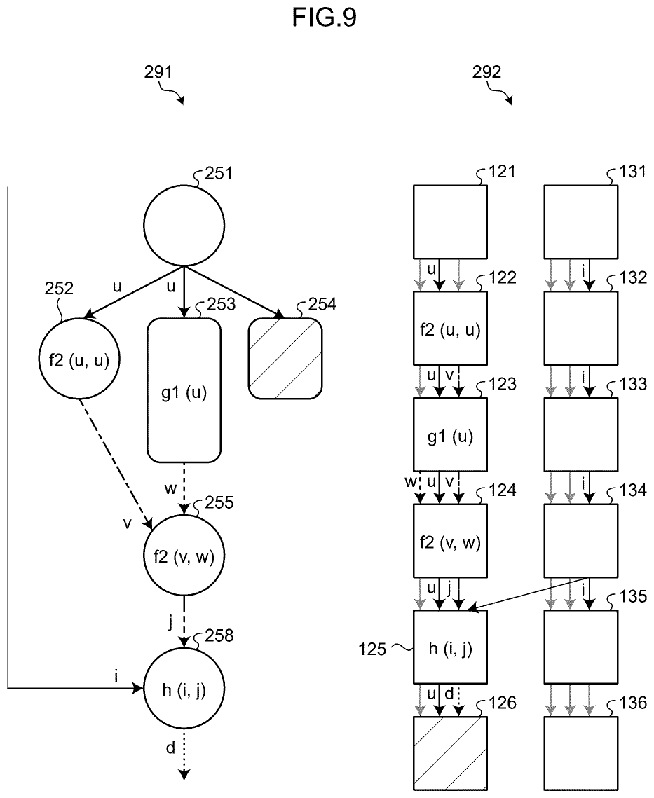

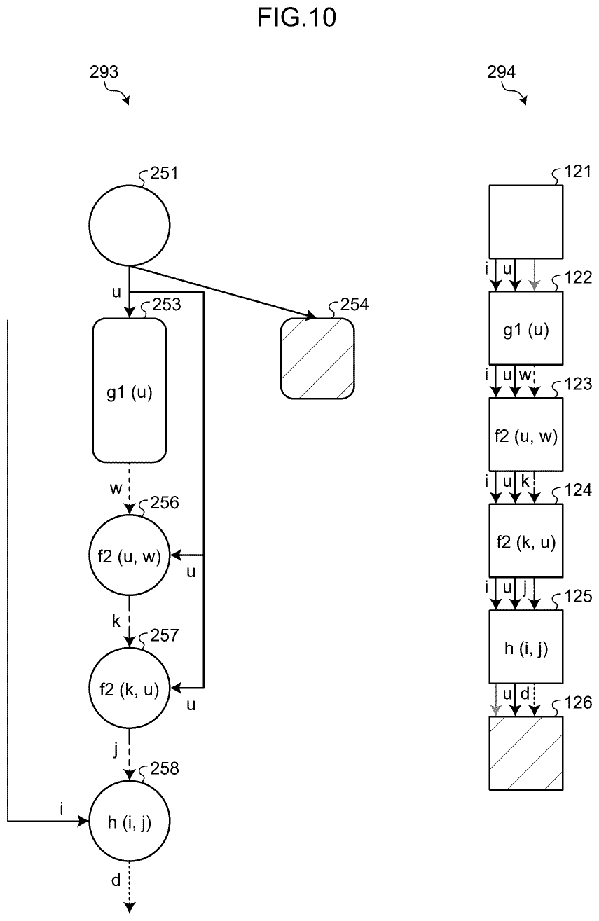

In the following, the effect of the reduction in the transmission column used for the data obtained as a result of the conversion of the DFG formed in the second pattern will be described in detail. FIG. 9 is a diagram illustrating one example of the DFG that includes the DFG formed in the second pattern. Furthermore, FIG. 10 is a diagram illustrating one example of conversion of the DFG including the DFG that has been formed in the second pattern.

For example, a description will be given in a case where a DFG 291 illustrated in FIG. 9 is converted. the DFG 291 is a DFG obtained by adding a node 258 that performs an arithmetic operation of h (i, j) by using the output value of j output from the DFG 205 as an argument and by using I as the other of the arguments to the DFG 205 that is the DFG formed in the second pattern illustrated in FIG. 7.

The DFG 291 is mapped as indicated by a mapping result 292. Here, mapping has also been performed such that the arithmetic operation to be performed by the partial DFG 254 is performed last. In the mapping result 292, the PEs 121 to 126 and 131 to 136 that are the twelve PEs 100 are used. The partial DFG 254 is mapped after the PE 126 that is indicated in the same pattern.

In the mapping result 292, three different output values are transmitted between the PE 123 and the PE 124 in order for the data transmission in the DFG formed in the second pattern. As a result of this, in order to transmit the data that is used for the arithmetic operation performed in the node 258 to the PE 125, a single piece of transmission column for transmitting the data needs to be added, in addition to the transmission column for transmitting the three types of data that can be transmitted by the PE 124. As a result of this, the two columns of the PEs 100 that are the column of the PEs 121 to 126 and the column of the PEs 131 to 136 are used.

Accordingly, by converting the DFG formed in the second pattern included in the DFG 291, a DFG 293 illustrated in FIG. 10 is generated. The DFG 293 is mapped as indicated by a mapping result 294. In the mapping result 294, the PEs 121 to 126 that are the six PEs 100 are used. The partial DFG 254 is mapped after the PE 126 that is indicated in the same pattern.

The DFG that is formed in the second pattern and that has been obtained after conversion includes a maximum of two data transmission columns, so that a single piece of data transmission column remains from among the three data transmission columns that connect the PEs 121 to 125. Accordingly, it is possible to transmit, by using the remaining data transmission column, the data that is to be input to the PE 125 that performs an arithmetic operation performed in node 258. As a result of this, as indicated in the mapping result 294, it is possible to limit the target for the mapping to the PEs 121 to 126 to the single piece of column used by the PE 100. In this case, the column used by the PE 100 including the PEs 131 to 136 that are to be used for the mapping performed in the original DFG 291 is able to be freely used by the mapping to be performed in the other DFG.

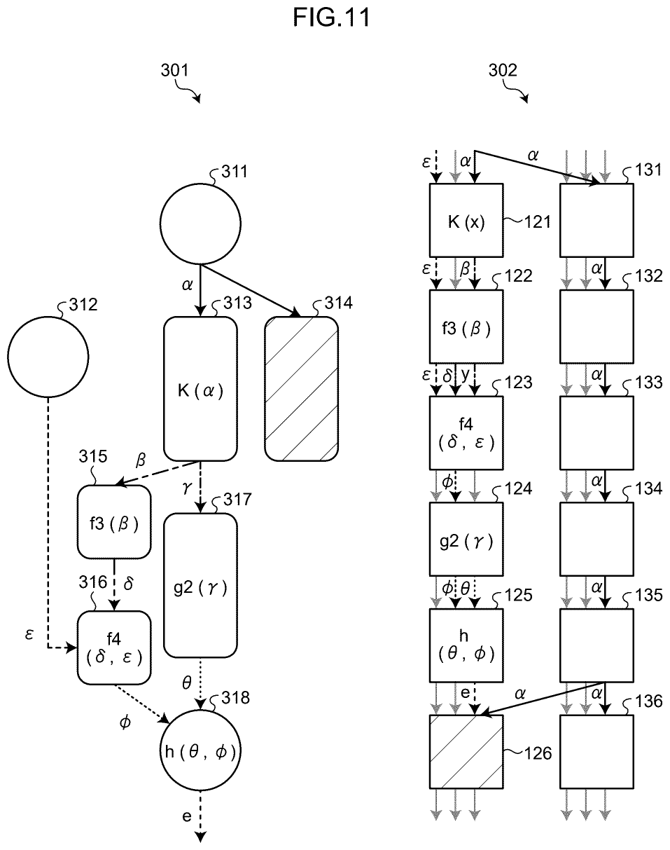

FIG. 11 is a diagram illustrating a third pattern of the DFG that is a candidate for a conversion candidate. In FIG. 11, a DFG 301 formed in the third pattern and a mapping result 302 obtained from the DFG 301 are illustrated.

For example, the DFG 301 includes a node 311, a node 312, a partial DFG 313, a partial DFG 314, a partial DFG 315, a partial DFG 316, a partial DFG 317, and a node 318. The node 311 outputs α as an output value to the partial DFG 313. Furthermore, the node 311 outputs an output value to the partial DFG 314. This output value is, for example, an arithmetic operation result obtained from the node 311. Furthermore, the node 312 outputs & as an output value to the partial DFG 316. This output value is, for example, an arithmetic operation result obtained from the node 312.

Furthermore, the partial DFG 313 performs an arithmetic operation of a function K (α) by using α that is the output value output from the node 311 as an argument, and outputs β as the output value based on the arithmetic operation result to the partial DFG 315. Furthermore, the partial DFG 313 performs an arithmetic operation of the function K (α) by using α that is the output value output from the node 311 as an argument, and outputs γ that is the output value based on the arithmetic operation result to the partial DFG 317.

The partial DFG 315 performs an arithmetic operation of a function f3 (β) by using β that is an output value output from the partial DFG 313 as an argument, and outputs δ as the output value based on the arithmetic operation result to the partial DFG 316. The partial DFG 317 performs an arithmetic operation of a function g2 (γ) by using γ as an output value output from the partial DFG 313 as an argument, and outputs θ as the output value based on the arithmetic operation result to the node 318. Furthermore, the partial DFG 316 performs an arithmetic operation of a function f4 (δ, ε) by using ε that is the output value output from the node 312 and using δ as the output value output from the partial DFG 315 as arguments, and outputs ϕ as the output value based on the arithmetic operation result to the node 318.

The node 318 performs an arithmetic operation of h (θ, ϕ) by using ϕ that is the output value output from the partial DFG 316 and θ that is the output value output from the partial DFG 317 as arguments. The partial DFG 314 performs a predetermined arithmetic operation by using the output value output from the node 311.

The DFG 301 is mapped as indicated by the mapping result 302. Here, mapping has been performed such that the arithmetic operation to be performed by the partial DFG 314. Furthermore, in the mapping result 302, in order to easily view the transmission column of the data, the nodes 311 and 312 that are included in the DFG 301 and each of which performs an output of the first data are not illustrated. In the mapping result 302, the PEs 121 to 126 and 131 to 136 that are the twelve PEs 100 are used. In this case, the partial DFG 313 is allocated to the PE 121, the partial DFG 315 is allocated to the PE 122, the partial DFG 316 is allocated to the PE 123, the partial DFG 317 is allocated to the PE 124, and the node 318 is allocated to the PE 125. The partial DFG 314 is mapped after the PE 126 that is indicated in the same pattern.

In this case, the output value output from the partial DFG 313 is used by the partial DFG 317, so that the output value output from the partial DFG 313 is held at the time of a start of the arithmetic operation of f2 (δ, ε) performed in the partial DFG 316. As a result of this, between the PE 122 and the PE 123, the three transmission columns for transmitting the data are used. Accordingly, in order to transmit the data that is used by the arithmetic operation performed in the partial DFG 314 to the PE 126, a single piece of the transmission column for transmitting the data is increased, in addition to the transmission columns for transmitting the three types of data that can be transmitted by the PE 122. As a result of this, the two columns of the two PEs 100 that are the column of the PEs 121 to 126 and the column of the PEs 131 to 136 are used.

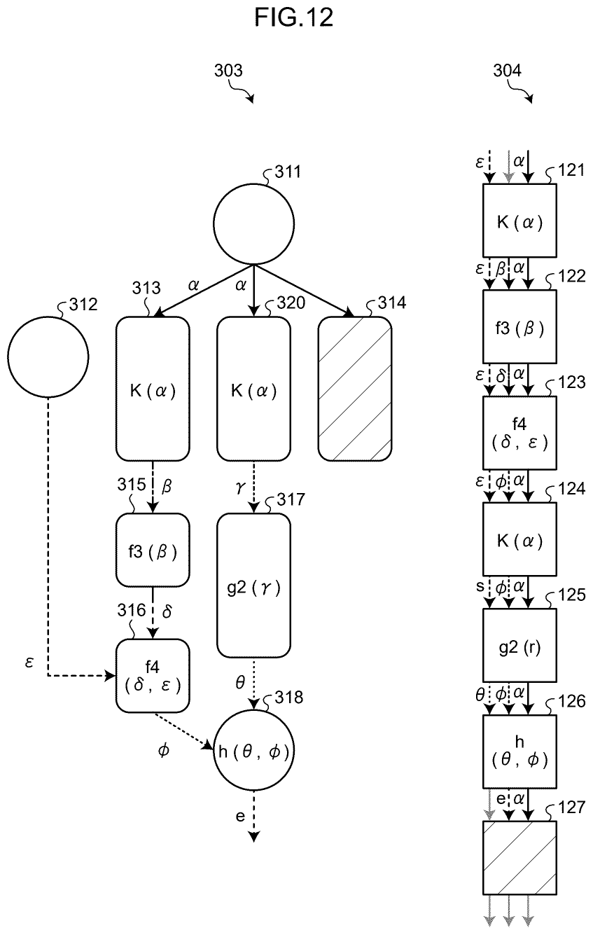

FIG. 12 is a diagram illustrating the DFG indicating after conversion obtained by converting the DFG formed in the third pattern. The DFG 301 is able to be replaced with a DFG 303. In this case, a partial DFG 320 obtained by duplicating the partial DFG 313 that is included in the DFG 301 formed in the third pattern is added. The partial DFG 313 performs an arithmetic operation of the function K (α) by using α that is the output value output from the node 311 as an argument, and outputs β that is the output value based on the arithmetic operation result to the partial DFG 315. Furthermore, the partial DFG 320 performs an arithmetic operation of the function K (α) by using α as the output value output from the node 311 as an argument, and outputs γ that is the output value based on the arithmetic operation result to the partial DFG 317. The other of the processes are the same as the process performed in the DFG 301 that has been formed in the third pattern.

To make generalization, a condition for the DFG that is formed in the third pattern is the following condition. The first partial DFG that is used by the two different partial DFGs each having a different output value are present. Here, the two paths used for the output value output from the first partial DFG are referred to as the first path and the second path. Furthermore, the first path and the second path are finally connected to a single node or a partial DFG. One of the first path and the second path has a structure of a multistage configuration that is formed of a combination of a plurality of nodes or DFGs. In one of the path having the multistage configuration between the first path and the second path, at least one input value needs not to be held at some stage. For example, the partial DFG 313 corresponds to one example of the first partial DFG, and the path through which the output value output from the partial DFG 313 is transmitted to the node 318 by way of the arithmetic operation performed by the partial DFGs 315 and 316 corresponds to one example of “the first path”. Furthermore, the path through which the output value output from the partial DFG 313 is transmitted to the node 318 by way of the arithmetic operation performed by the partial DFG 317 corresponds to one example of “the second path”. The output value that is input to the first partial DFG is used by a different partial DFG or a different node. In addition, in a case where a DFG formed in a too much size is converted, there is a possibility that the number of arithmetic operations increases, so that it is preferable to add a condition that the number of nodes included in the first partial DFG is equal to or less than a threshold.

In other words, in the DFG 301, in a case where the node 311 is denoted by the first node, the partial DFG 313 is denoted by the second node, and each of the partial DFG 315 and the partial DFG 316 is denoted by the third node. Furthermore, in a case where the partial DFG 317 is denoted by the fourth node, the node 318 is denoted by the fifth node, and the partial DFG 314 is denoted by the sixth node, the third pattern is able to represented as follows. The third pattern includes the first node. Furthermore, the third pattern includes the second node that performs an arithmetic operation by using the output value output from the first node. Furthermore, the third pattern includes the third nodes that are the plurality of nodes each of which performs consecutive arithmetic operations by using the output value output from the second node and is able to discard one of the values that is used for the arithmetic operation performed in each of the nodes after the arithmetic operation has been performed. Furthermore, the third pattern includes the fourth node that performs an arithmetic operation by using the output value output from the second node. Furthermore, the third pattern includes the fifth node that performs an arithmetic operation by using the output value output from the third node and the output value output from the fourth node as arguments. In addition, the third pattern includes the sixth node that received an input of the output value output from the first node.

The DFG that has been formed in the third pattern and that satisfies the above described condition is able to be converted as described below. By duplicating the first partial DFG, a first duplication partial DFG is generated. It is assumed that an input of the first duplication partial DFG is the same as the input of the first partial DFG. Furthermore, instead of the output value output from the first partial DFG, the output value output from the first duplication partial DFG is used in the second path.

In a case where this conversion has been performed, for example, the DFG 303 obtained after conversion is mapped as indicated by a mapping result 304. Here, mapping has also been performed such that the arithmetic operation to be performed by the partial DFG 314 is performed last. In the mapping result 304, in order to easily view the transmission column of the data, the nodes 311 and 312 that are included in the DFG 303 and each of which performs an output of the first data are not illustrated. In the mapping result 304, the PEs 121 to 126 that are the six PEs 100 are used. In this case, the partial DFG 313 is allocated to the PE 121, the partial DFG 315 is allocated to the PE 122, and the partial DFG 316 is allocated to the PE 123. Furthermore, the partial DFG 320 is allocated to the PE 124, the partial DFG 317 is allocated to the PE 125, and the node 318 is allocated to the PE 126. The partial DFG 314 is mapped after the PE 127 that is indicated in the same pattern. In the mapping result 304, the same data is transmitted by using the line with the same type as that of the line that indicates the flow of the data and that has been used in the DFG 303. Furthermore, the line indicated in gray is a path through which arbitrary data is allowed to pass. In other words, in a case of the mapping result 304, three transmission columns for transmitting the data are used.

In the mapping result 304, as compared with the mapping result 302 illustrated in FIG. 11, it is possible to reduce a single piece of the transmission column that is used to transmit the data. In other words, it is possible to flow the data included in another DFG through the transmission column that has been used for the reduced piece of data, and as a whole, it is possible to improve the utilization efficiency of the PEs 100.

Here, in the present embodiment, the above described three patterns used for the DFG are the patterns that are able to reduce the number of transmission columns for transmitting the data and that are candidates for the DFG conversion candidate, but the patterns that become a conversion candidate for the DFG are not limited to these three patterns. As a pattern that is able to reduce the number of transmission columns for transmitting the data, various patterns are conceivable, and it is preferable that a pattern to be used is selected in accordance with the size of the DFG and the calculation to be performed.

A description will be given here by referring back to FIG. 3. The extraction unit 102 extracts a portion of the DFG formed in one of the described above first to the third patterns from the DFG that has been given by the user, and outputs the information on the extracted portion and the information on the pattern of the DFG corresponding to each of the portions to the candidate determination unit 103.

The candidate determination unit 103 receives, from the extraction unit 102, an input of the information on the portion that has been extracted from the given DFG and the information on the pattern of the DFG corresponding to each of the portions. Furthermore, the candidate determination unit 103 stores therein in advance the information on the priority in accordance with the type of the pattern of the conversion. In the present embodiment, the candidate determination unit 103 stores therein the information on the priority indicating that the first pattern is the highest priority, the second pattern is the second highest priority, the third pattern is the lowest priority. Then, the candidate determination unit 103 generates the information on the DFG conversion candidate for the DFG that is applicable to each of the extracted portions in the given DFG.

Here, it is also possible to apply the conversion of the DFG formed in a plurality of types of patterns to the same portion. In a case where the candidate determination unit 103 applies the conversion of the DFG formed in the plurality of types of patterns to the same portion, the candidate determination unit 103 generates a DFG conversion candidate such that the minimum number is to be used to reduce the number of transmission columns that are used to transmit the data. For example, even when the first pattern is included in the DFG formed in the second pattern, there may be a case in which, regarding the number of data columns, the reduction in the number of transmission columns used for the data using the first pattern does not exert influence on a reduction in the number of transmission columns used for the data obtained from the conversion of the DFG formed in the second pattern in terms of the subject DFG as a whole. In this case, the candidate determination unit 103 regards the subject portion in the DFG formed in the second pattern as the DFG conversion candidate and does not regard the DFG formed in the first pattern as the DFG conversion candidate. Furthermore, in a case where the conversion of the DFG formed in a pattern that is not able to be used for the same portion at the same time, the candidate determination unit 103 selects the DFG formed in the pattern having the higher priority as the DFG conversion candidate.

Then, the candidate determination unit 103 selects a DFG conversion candidate that is able to be used for the conversion of the actually given DFG from among the generated DFG conversion candidates by using the method that will be described below, and determines the application DFG.

Here, converting the DFG that has been given all of the DFG conversion candidates specified by the extraction unit 102 does not always result in obtaining a more efficient DFG. For example, in a case of the conversion of DFG formed in the first pattern, the length of a critical path may possibly increase. Furthermore, in a case of the conversion of DFG formed in the second pattern, the length of a critical path may possibly increase by an amount corresponding to a conversion portion. Furthermore, in a case of the conversion of DFG formed in the third pattern, the number of arithmetic operations may possibly increase. In addition, as a result of an increase in the length of the critical path and increase in the number of arithmetic operations, the number of transmission columns used for the data may increase from that before the conversion, and it may be difficult to perform the mapping into the CGRA 110.

Accordingly, the candidate determination unit 103 selects an application DFG that is used to the conversion in accordance with the priority from among the DFG conversion candidates such that the length of the critical path of the DFG that has been given by the user and that is obtained after conversion is within an executable range in the CGRA 110.

After that, the candidate determination unit 103 outputs the information on the portion to be converted in the DFG that has been given by the user and the information on the pattern of the application DFG with respect to the subject portion to the DFG conversion unit 104 together with the DFG that has been given by the user.

The DFG conversion unit 104 receives an input of the information on the portion to be converted in the DFG that has been given by the user and the information on the pattern of the application DFG with respect to the subject portion from the candidate determination unit 103. Then, the DFG conversion unit 104 converts, for each designated portion to be converted, the DFG in accordance with the type of the pattern of the application DFG. In a case where the application DFG formed in a plurality of patterns is present in a single portion, the DFG conversion unit 104 performs conversion on the entire DFG in accordance with each of the patterns. After that, the DFG conversion unit 104 outputs the converted DFG that has been subjected to the conversion in which the transmission columns used for the data is decreased has been performed on the DFG that has been given by the user to the notification unit 105.

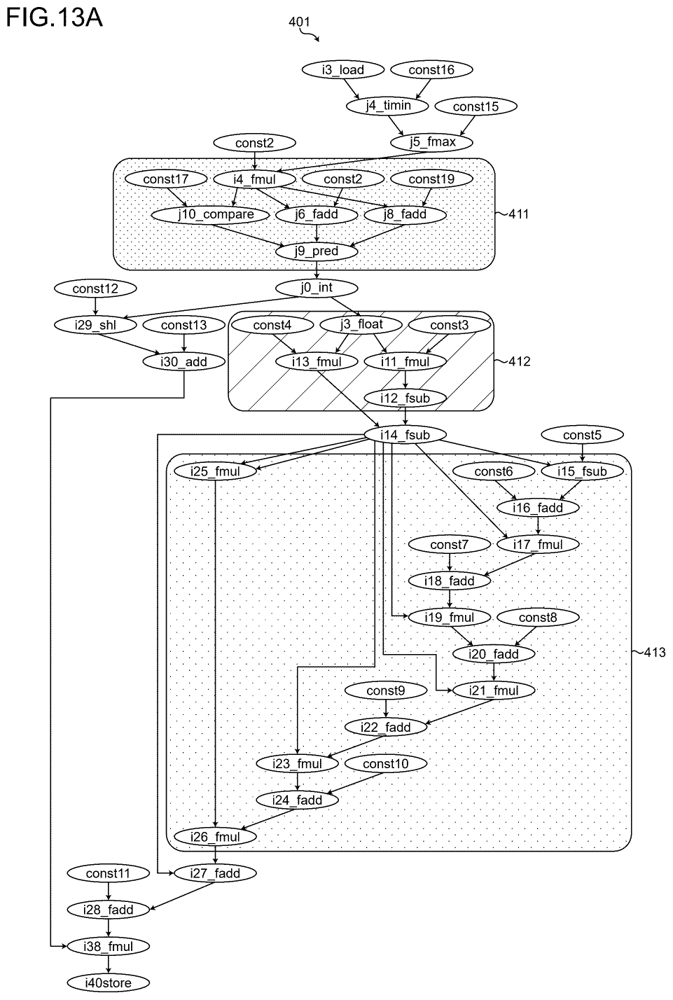

FIGS. 13A and 13B are a diagram illustrating an application example of the conversion of the DFG. For example, a description will be given by using a case in which a DFG 401 illustrated in FIG. 13A has been given by the user. In the DFG 401, an application portion 411 is a portion in which conversion of the DFG formed in the first pattern is applicable. Furthermore, an application portion 412 is a portion in which conversion of the DFG formed in the second pattern is applicable. Furthermore, an application portion 413 is a portion in which conversion of the DFG formed in the third pattern is applicable.

Accordingly, the DFG conversion unit 104 performs conversion of the DFG formed in the first pattern on the application portion 411, and converts the application portion 411 to an after converted DFG 421 included in a converted DFG 402 illustrated in FIG. 13B Furthermore, the DFG conversion unit 104 performs conversion of the DFG formed in the second pattern on the application portion 412, and converts the application portion 412 to an after converted DFG 422 included in the converted DFG 402. Furthermore, the DFG conversion unit 104 performs conversion of the DFG formed in the third pattern on the application portion 413, and converts the application portion 413 to an after converted DFG 423 included in the converted DFG 402. In this way, the DFG conversion unit 104 converts the DFG 401 that has been given by the user and generates the converted DFG 402. In this case, the converted DFG 402 is consequently able to perform mapping at the same time in the form of holding a maximum of three pieces of data, and is thus able to perform mapping on the PE 100 arranged in a single column.

The notification unit 105 receives, from the DFG conversion unit 104, an input of the converted DFG that has been converted such that the number of transmission columns used for the data has been reduced with respect to the DFG that has been given by the user. Then, the notification unit 105 transmits the converted DFG to the mapping device 11, and instructs the mapping device 11 to perform the mapping by using the transmitted converted DFG.

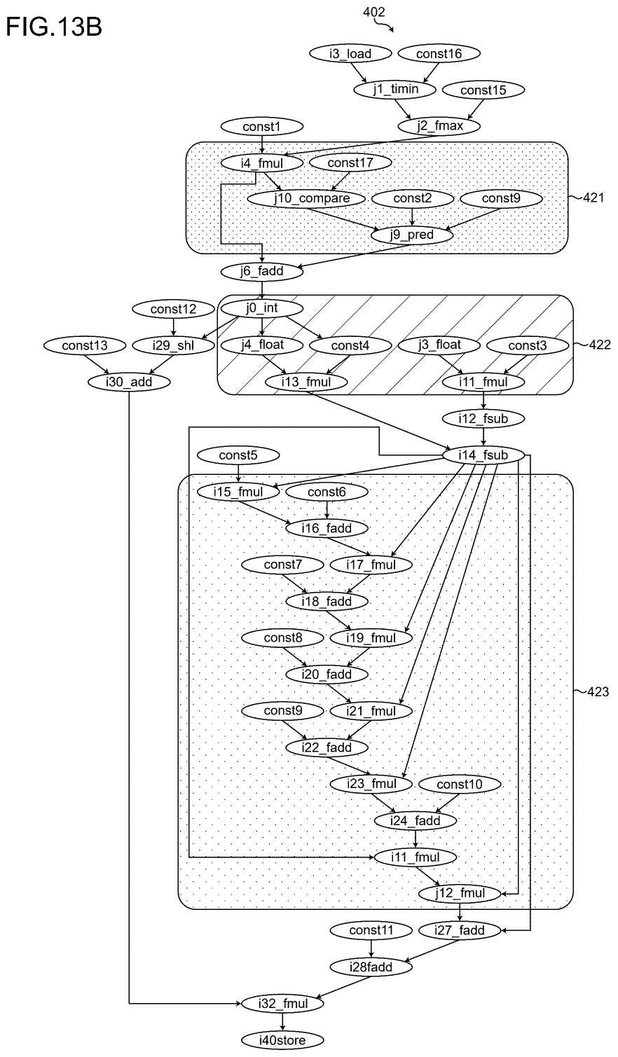

FIG. 14 is a flowchart of the flow of the generation process of generating the DFG conversion candidate. In the following, the flow of the generation process of generating the DFG conversion candidate will be described with reference to FIG. 14.

The extraction unit 102 extracts the portions corresponding to the DFG formed in the predetermined pattern from the DFG that has been given by the user (Step S1).

The candidate determination unit 103 selects a single portion from among the extraction portions extracted by the extraction unit 102 (Step S2).

Then, the candidate determination unit 103 specifies a mapping location corresponding to the selected extraction portion in the mapping result that has been acquired from the mapping device 11 (Step S3).

Then, the candidate determination unit 103 specifies all of the other extraction portions that are to be mapped into the PE 100 located in the row included in the specified location (Step S4).

Then, the candidate determination unit 103 sets the number of simultaneous pieces of data to be held that is reduced in a case where the conversion of the DFGs formed in all of the patterns performed on the selected extraction portion and the specified extraction portion is applied to the selected extraction portion to n (Step S5).

Then, the candidate determination unit 103 uses the number of routing lines to be used for the data transfer performed on the PE 100 located in the row in which the number of simultaneous pieces of data to be held is the maximum as k, and performs calculation by dividing k by 3 with a remainder of m (Step S6). In other words, m=k mod 3 holds. Here, the value of “3” to be divided indicates the number of types of the data that is able to be transmitted between the PEs 100 in the present embodiment. This number depends on the architecture of the CGRA 110.

Then, the candidate determination unit 103 determines whether or not m is equal to or less than n (Step S7). If m is greater than n (No at Step S7), the candidate determination unit 103 proceeds to Step S10.

In contrast, if m is less than n (Yes at Step S7), the candidate determination unit 103 adds conversion of the DFG formed in m patterns having high priority included in the conversion of the DFG formed in the pattern to be performed on the selected extraction portion and specified extraction portion to the DFG conversion candidate (Step S8).

Then, the candidate determination unit 103 adds the conversion of the DFG formed in (n−m)−((n−m) mod 3) patterns having high priority from among the patterns except for the patterns used in the DFG conversion candidate to the DFG conversion candidate (Step S9).

The candidate determination unit 103 determines whether or not the selection of the DFG conversion candidate related to all of the extraction portions has been completed (Step S10). If an extraction portion in which selection of the DFG conversion candidate has not been performed remains (No at Step S10), the candidate determination unit 103 returns to Step S2.

In contrast, if selection of the DFG conversion candidate related to all of the extraction portions has been completed (Yes at Step S10), the candidate determination unit 103 determines the DFG conversion candidate selected at that time as the DFG conversion candidate that is possibly and actually be used (Step S11).

In the following, an extraction process of extracting a portion of the DFG formed in each of the first to the third patterns will be respectively described. The process described below corresponds to one example of the process performed at Step S1 illustrated in FIG. 14.

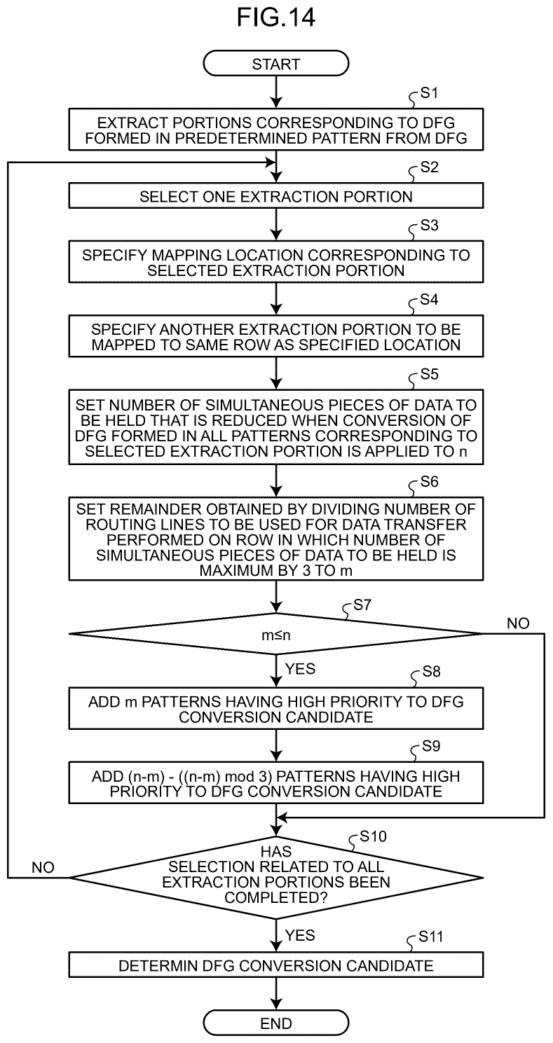

FIG. 15 is a flowchart of the flow of the extraction process of extracting the portion of the DFG formed in the first pattern. One example of the flow of the extraction process of extracting the portion of the DFG formed in the first pattern will be described with reference to FIG. 15.

The extraction unit 102 specifies the first node that performs the predication in the given DFG (Step S101).

Then, the extraction unit 102 determines whether or not a common ancestor of the second node and the third node that are the output source of the values of then and else in the predication is present (Step S102). In other words, the extraction unit 102 determines whether or not to reach the same node when tracing back the DFG from the second node and the third node.

If a common ancestor of the second node and the third node is present (Yes at Step S102), the extraction unit 102 determines whether or not the functions used by the second node and the third node are the same except for the constant portion corresponding to an argument (Step S103).

If the functions are the same except for the constant portion corresponding to an argument (Yes at Step S103), the extraction unit 102 extracts a portion corresponding to the DFG that has been formed in the first pattern and that includes the first to the third nodes (Step S104).

In contrast, if a common ancestor of the second node and the third node is not present (No at Step S102), or if the functions are not the same except for the constant portion corresponding to an argument (No at Step S103), the extraction unit 102 performs the following process. The extraction unit 102 determines that the portion corresponding to the DFG that has been formed in the first pattern and that includes the first to the third nodes is not present (Step S105).

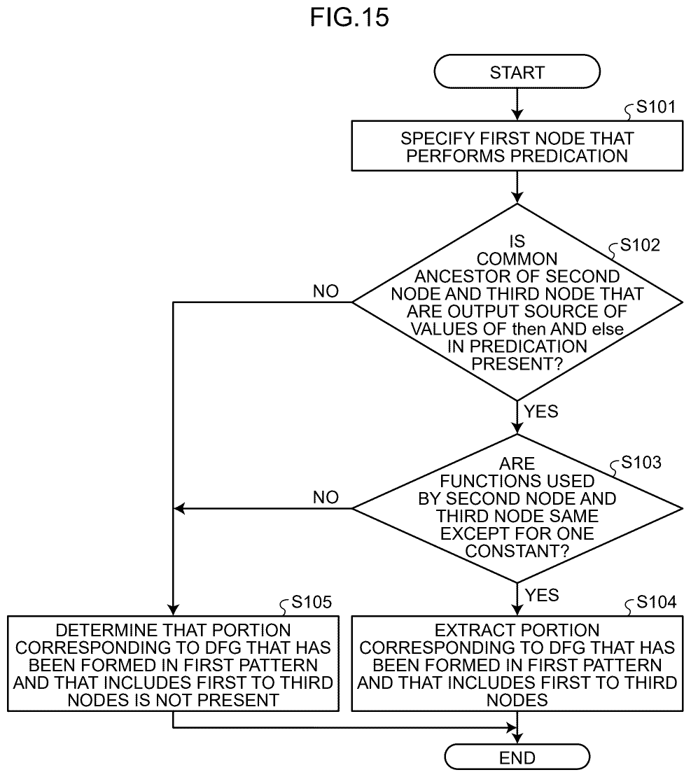

FIG. 16 is a flowchart illustrating the flow of the extraction process of extracting the portion of the DFG formed in the second pattern. One example of the flow of the extraction process of extracting the portion of the DFG formed in the second pattern will be described with reference to FIG. 16.

The extraction unit 102 specifies the second node that performs the arithmetic operation of the function f that satisfies the associative law (Step S111).

The extraction unit 102 determines whether or not the two values that are used for the arithmetic operation of the function f performed by the second node are the same (Step S112).

If the two values that are used for the arithmetic operation of the function f performed by the second node are the same (Yes at Step S112), the extraction unit 102 specifies the first node that outputs the output value to be input to the second node (Step S113).

The extraction unit 102 determines whether or not the arithmetic operation result obtained from the second node is an argument to be used for the third node that performs the same arithmetic operation (Step S114).

If the arithmetic operation result obtained from the second node is an argument to be used for the third node that performs the same arithmetic operation (Yes at Step S114), the extraction unit 102 specifies the fourth node that uses another argument to be used for the third node as an output value (Step S115).

The extraction unit 102 determines whether or not the output value output from the first node is input to the fourth node (Step S116).

If the output value output from the first node is input to the fourth node (Yes at Step S116), the extraction unit 102 extracts a portion corresponding to the DFG that has been formed in the second pattern and that includes the first to the fourth nodes (Step S117).

In contrast, if the two values that are used for the arithmetic operation of the function f performed by the second node are different (No at Step S112), the extraction unit 102 performs the process described below.

Furthermore, similarly, if the arithmetic operation result obtained from the second node is not an argument to be used for the third node that performs the same arithmetic operation (No at Step S114) and if the output value output from the first node is not input to the fourth node (No at Step S116), the extraction unit 102 performs the process described below. The extraction unit 102 determines that the portion corresponding to the DFG that has been formed in the second pattern and that includes the first to the fourth nodes is not present (Step S118).

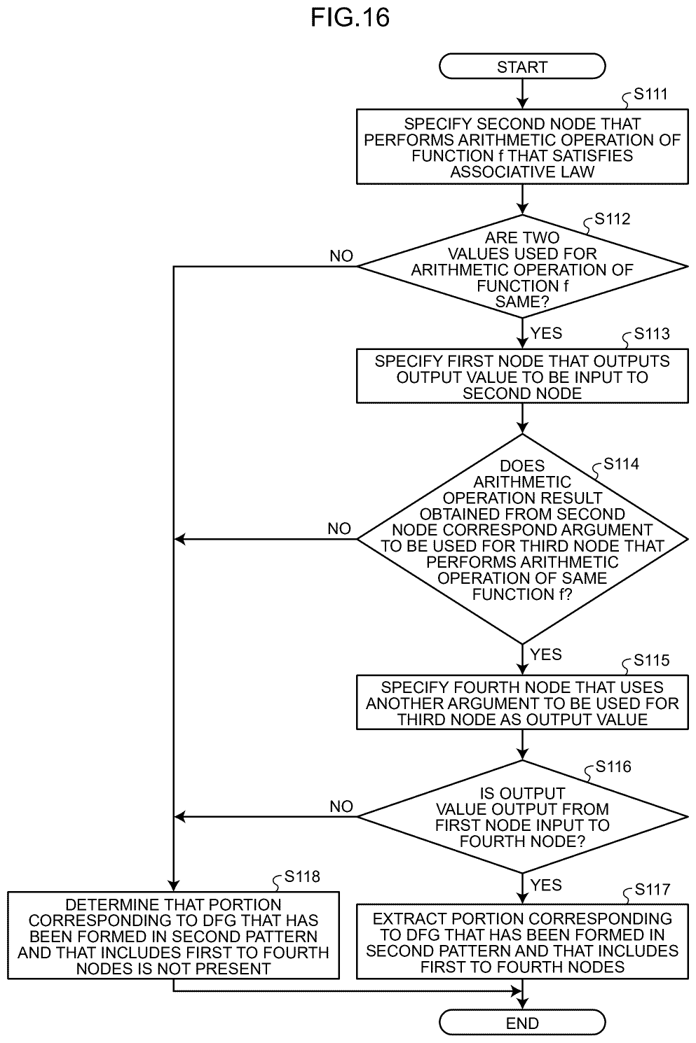

FIG. 17 is a flowchart illustrating the extraction process of extracting the portion of the DFG formed in the third pattern. One example of the flow of the extraction process of extracting the portion of the DFG formed in the third pattern will be described with reference to FIG. 17.

The extraction unit 102 specifies a partial graph in which an output value is used by the two paths of the first and the second paths (Step S121).

Then, the extraction unit 102 determines whether or not the number of nodes included in the specified partial graph is equal to or less than the threshold (Step S122).

If the number of nodes included in the specified partial graph is equal to or less than the threshold (Yes at Step S122), the extraction unit 102 determines whether or not the calculation results of the first and the second paths are confluent (Step S123). In other words, the extraction unit 102 determines whether or not both of the first path and the second path are connected to the same node or the same partial DFG.

If the calculation results of the first and the second paths are confluent (Yes at Step S123), the extraction unit 102 determines whether or not one of the paths is a multistage, and also, determines whether or not an input value that is able to be discarded is present in the multistage path up to a confluent point (Step S124).

If one of the paths is a multistage, and also, the input value that is able to be discarded is present in the multistage path up to a confluent point (Yes at Step S124), the extraction unit 102 determines whether or not the output value to be input to the partial graph is input to the other partial DFG (Step S125).

If the output value to be input to the partial graph is input to the other partial DFG (Yes at Step S125), the extraction unit 102 extracts the portion corresponding to the partial graph, the DFG that has been formed in the third pattern and that includes the first path and the second path (Step S126).

In contrast, if the number of nodes included in the specified partial graph is equal to or greater than the threshold (No at Step S122), the extraction unit 102 determines that the portion corresponding to the DFG formed in the third pattern is not present (Step S127).

Furthermore, if the calculation results of the first and the second paths are not confluent (No at Step S123), the extraction unit 102 also determines that the portion corresponding to the DFG formed in the third pattern is not present (Step S127). Furthermore, if both of the paths are not a multistage, and also, if an input value that is able to be discarded is not present in the multistage path up to a confluent point (No at Step S124), the extraction unit 102 also determines that the portion corresponding to the DFG formed in the third pattern is not present (Step S127). Furthermore, if the output value to be input to the partial graph is not input to the other partial DFG (No at Step S125), the extraction unit 102 also determines that the partial graph and the portion corresponding to the DFG formed in the third pattern are not present (Step S127).

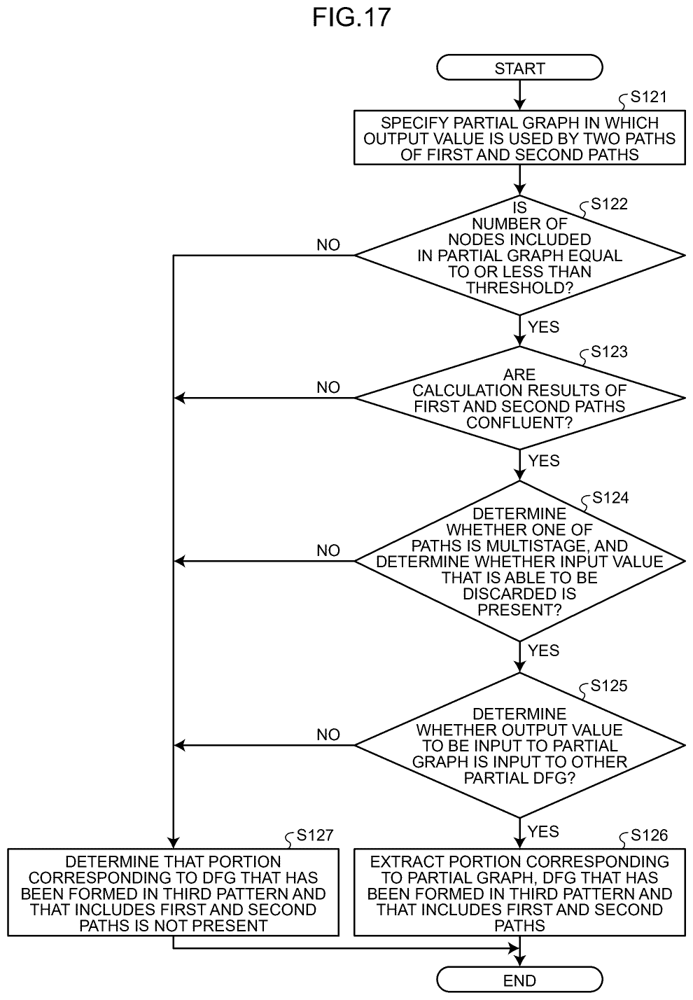

FIG. 18 is a flowchart illustrating the flow of a DFG candidate determination process and a generation process of generating a converted DFG. In the following, the flow of a DFG candidate determination process and a generation process of generating a converted DFG will be described with reference to FIG. 18.

The candidate determination unit 103 generates the DFG conversion candidate (Step S21). The processes at Steps S2 to S11 performed by the candidate determination unit 103 in the flow illustrated in FIG. 14 corresponds to one example of this process.

Then, the candidate determination unit 103 acquires the priority of each of the patterns of the DFG to be converted (Step S22).

Then, the candidate determination unit 103 selects the pattern having the highest priority from among the patterns that have not been selected (Step S23).

When the candidate determination unit 103 uses the DFG conversion candidate formed in the selected pattern and performs conversion on the corresponding extraction portion, the candidate determination unit 103 determines whether or not the path length exceeds the number of rows of the CGRA 110 (Step S24). When the candidate determination unit 103 performs the conversion, if the extraction portion in which the path length does not exceed the number of rows of the CGRA 110 is not present (No at Step S24), the candidate determination unit 103 proceeds to Step S26.

In contrast, if the extraction portion in which the path length does not exceed the number of rows of the CGRA 110 is present (Yes at Step S24), the candidate determination unit 103 selects the DFG conversion candidate formed in the selected pattern with respect to the corresponding extraction portion as an application DFG (Step S25).

After that, the candidate determination unit 103 determines whether or not the application DFG has been examined with respect to all of the patterns (Step S26). If the application DFG that has not been examined with respect to the pattern is present (No at Step S26), the candidate determination unit 103 returns to Step S23.

In contrast, if the application DFG has been examined with respect to all of the patterns (Yes at Step S26), the candidate determination unit 103 notifies the application DFG related to each of the extraction portions to the DFG conversion unit 104 (Step S27).

The DFG conversion unit 104 performs conversion on each of the extraction portions included in the given DFG based on the application DFG, and generates the converted DFG (Step S28).

In the following, the conversion process of converting the DFG formed in each of the first to the third patterns performed by the DFG conversion unit 104 will be described. The process that will be described below corresponds to one example of the process performed at Step S28 illustrated in FIG. 18.

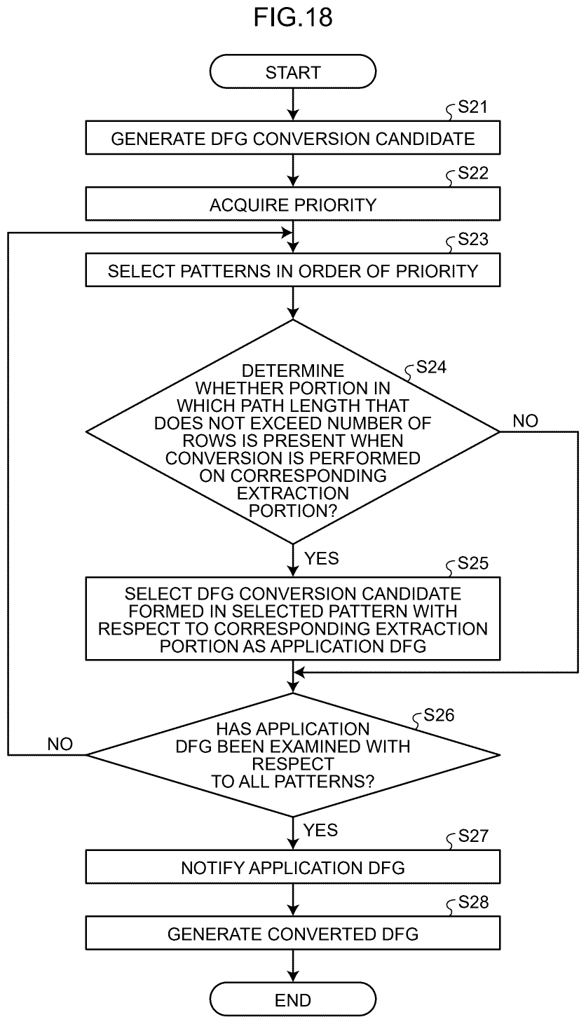

FIG. 19 is a flowchart illustrating the flow of the conversion process of converting the DFG formed in the first pattern. One example of the flow of the conversion process of converting the DFG formed in the first pattern will be described with reference to FIG. 19. Here, it is assumed that the node that performs the predication is the first node, the node that outputs an output value that is used as the value of then indicated in the first node is the second node, and the node that outputs an output value that is used as the value of else indicated in the first node is the third node. Furthermore, the constant that is used in the arithmetic operation of the function f performed by the second node is denoted by c1, and the constant that is used in the arithmetic operation of the function f performed by the third node is denoted by c2. In addition, it is assumed that the node that receives an input of the output value output from the first node is the fourth node.

The DFG conversion unit 104 replaces then with c1, and replaces else with c2 that are indicated in the predication in the first node (Step S201).

Next, the DFG conversion unit 104 deletes one of the second node and the third node. Then, the DFG conversion unit 104 regards an input of the node between the remaining second node or the third node as an output from the first node. Furthermore, the DFG conversion unit 104 replaces the constant portion in the function f indicated in the remaining node between the second node and the third node with the output value output from the first node (Step S202).

Then, the DFG conversion unit 104 replaces an input into the fourth node with an output from the remaining node between the second node and the third node, from the output from the first node (Step S203).

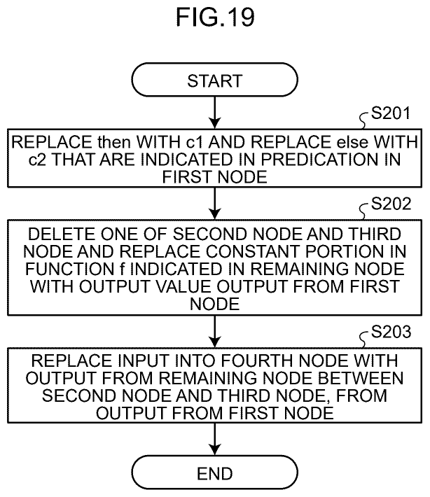

FIG. 20 is a flowchart illustrating the flow of the conversion process of converting the DFG formed in the second pattern. One example of the flow of the conversion process of converting the DFG formed in the second pattern will be described with reference to FIG. 20. Here, it is assumed that the node 252 that is illustrated in FIG. 7 and that performs the arithmetic operation of the function f that satisfies the associative law is the second node. Furthermore, it is assumed that the node 251 that is illustrated in FIG. 7 and whose output value corresponds to an input to the second node is the first node.

Furthermore, it is assumed that the node 255 that is illustrated in FIG. 7 to which the output value output from the second node is input is the third node. Furthermore, it is assumed that the partial DFG 253 that is illustrated in FIG. 7 and that outputs an output value to the third node in response to an input of the output value output from the first node is the fourth node.

the DFG conversion unit 104 deletes the second and the third nodes (Step S211).

Then, the DFG conversion unit 104 adds the node, as the sixth node, that performs the arithmetic operation of the function f that satisfies the associative law by using both of the output from the fourth node and the output from the first node (Step S212). The sixth node described here corresponds to the node 256 illustrated in FIG. 8.

Then, the DFG conversion unit 104 adds the seventh node that performs the arithmetic operation of the function f by using both of the output from the sixth node and the output from the first node (Step S213). The sixth node described here corresponds to the node 257 illustrated in FIG. 8.

Furthermore, the DFG conversion unit 104 regards an input of the node, in which the output from the third node has been input, as an output from the seventh node (Step S214).

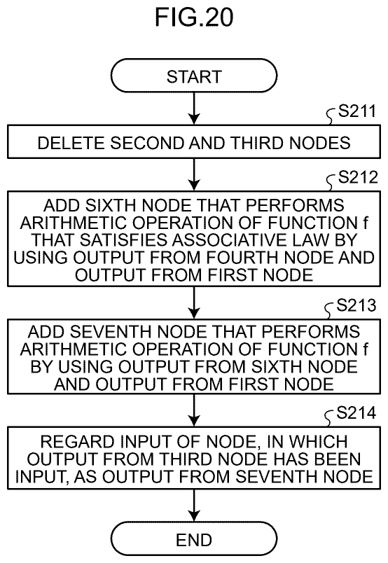

FIG. 21 is a flowchart illustrating the conversion process of converting the DFG formed in the third pattern. The example of the flow of the conversion process of the DFG formed in the third pattern will be described with reference to FIG. 21. Here, it is assumed that the partial DFG 313 that is illustrated in FIG. 11 and whose output value is used by the two path is the second node. Furthermore, it is assumed that the node 311 that is illustrated in FIG. 11 and whose output value corresponds to an input to the third node is the first node.

Furthermore, it is assumed that the partial DFG 317 that is illustrated in FIG. 11 and that receives an input of the output value output from the second node in the path that is not a multistage between the first path and the second path that uses the output value output from the second node is the third node.

The DFG conversion unit 104 duplicates the second node and generates the fourth node (Step S221). The fourth node generated in this case corresponds to the partial DFG 320 illustrated in FIG. 12.

Then, the DFG conversion unit 104 regards an input of the fourth node as an output from the first node (Step S222).

Then, the DFG conversion unit 104 replaces the input of the third node with the output from the fourth node, from the output from the second node (Step S223).

As described above, the DFG conversion device 10 according to the present embodiment extracts the DFG formed in a predetermined pattern included in the given DFG, and specifies the portion in which the extracted DFG has been mapped from the mapping result. Then, the DFG conversion device 10 extracts another pattern that uses the row of the same PE 100 included in the specified portion, and determines the conversion candidate DFG in accordance with the number of reductions in the transmission column of the data. Furthermore, the DFG conversion device 10 specifies, in accordance with the priority, the conversion candidate DFG that is included in the conversion candidate DFG and whose path length fits within the CGRA 110, uses the specified conversion candidate DFG as the application DFG, and generates the converted DFG obtained by converting the DFG that has been given by using the application DFG. As a result of this, it is possible to perform the mapping on the given DFG in a state in which the number of transmission columns of the data has been reduced while maintaining the calculation to be performed, and it is thus possible to perform efficient mapping. In addition, by performing the efficient mapping, it is possible to improve the efficiency of use of the PE 100, and it is thus possible to improve the processing capacity of the CGRA 110.

### Hardware Configuration

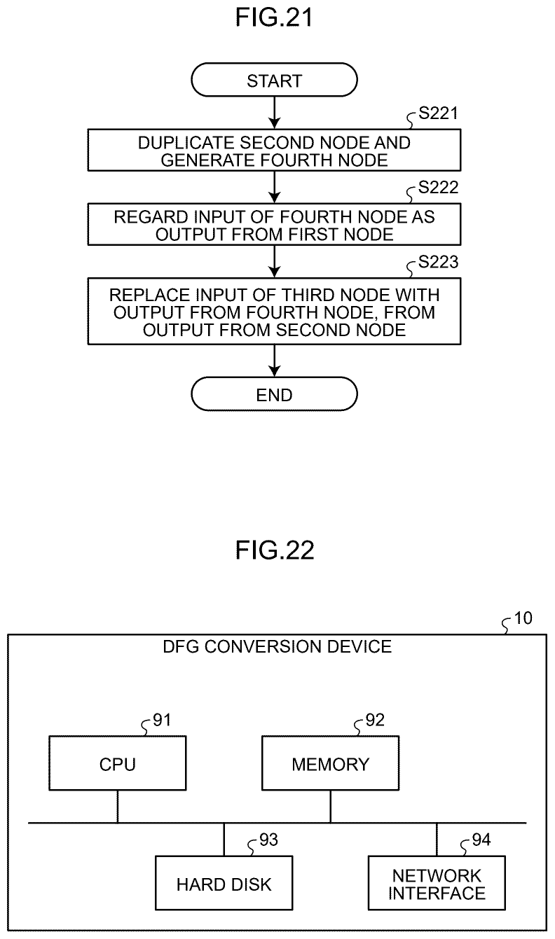

FIG. 22 is a diagram illustrating a hardware configuration of the DFG conversion device. In the following, one example of the hardware configuration for implementing each of the functions of the DFG conversion device 10 will be described with reference to FIG. 22.

As illustrated in FIG. 22, the DFG conversion device 10 includes, for example, a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the DFG conversion device 10 and an external device. The network interface 94 relays communication between, for example, the mapping device 11 and the CPU 91.

The hard disk 93 is an auxiliary storage device. The hard disk 93 stores therein various kinds programs including the programs for implementing the functions of the data collection unit 101, the extraction unit 102, the candidate determination unit 103, the DFG conversion unit 104, and the notification unit 105 illustrated in FIG. 1.

The memory 92 is a main storage device. For example, a dynamic random access memory (DRAM) may be used for the memory 92.

The CPU 91 reads out the various kinds of programs from the hard disk 93, loads the read programs into the memory 92, and executes the programs. As a result of this, the CPU 91 implements the function of the data collection unit 101, the extraction unit 102, the candidate determination unit 103, the DFG conversion unit 104, and the notification unit 105.

Furthermore, in the present embodiment, the description has been given of a case in which the DFG conversion device 10 and the mapping device 11 included in the automatic mapper 1 are constituted as different devices, but the embodiment is not limited to this. It is possible to constitute the DFG conversion device 10 and the mapping device 11 as a single device.

According to an aspect of one embodiment, the present invention is able to improve the processing capacity.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a conversion program that causes a computer to execute a process comprising:
acquiring a predetermined original data flow graph (DFG) and a mapping result of mapping of the DFG with respect to a coarse-grained reconfigurable architecture (CGRA) that includes a plurality of arithmetic operation units, the mapping result including information that is related to allocation of an arithmetic operation to each of the arithmetic operation units and is related to a routing line between the arithmetic operation units and that has been determined so as to correspond to the predetermined original DFG;
extracting, from the predetermined original DFG, a portion corresponding to a pattern that is formed in the DFG and that has been determined in advance;
determining a conversion candidate DFG that is included in the DFG corresponding to the pattern of an extraction portion based on a location in which the extraction portion has been allocated and that is indicated in the mapping result and based on the number of transmission paths for data used between the arithmetic operation units indicated in the mapping result; and
generating a converted DFG based on the conversion candidate DFG by converting the predetermined original DFG.

2. The non-transitory computer-readable recording medium according to claim 1, further comprising selecting, from among the conversion candidate DFGs, an application DFG in which mapping of a converted DFG obtained by performing predetermined conversion on the conversion candidate DFG included in the predetermined original DFG can be mapped into the CGRA, wherein
the generating the converted DFG generating the converted DFG by converting the predetermined original DFG by using the application DFG.

3. The non-transitory computer-readable recording medium according to claim 1, wherein
the extracting includes extracting at least a portion corresponding to a first pattern that includes
a first node and a second node,
a third node and a fourth node each of which performs an arithmetic operation of a first function by using two arguments, one of the two arguments being a fixed value, and the other of the two arguments being an output value output from the first node, and
a fifth node that uses, as an output value, one of an output value output from the third node and an output value output from the fourth node in accordance with a determination result obtained by using an output value output from the second node as a determination condition.

4. The non-transitory computer-readable recording medium according to claim 1, wherein
the extracting includes extracting at least a portion corresponding to a second pattern that includes
a first node,
a second node that performs an arithmetic operation of a second function that satisfies an associative law and that uses two arguments by using an output value output from the first node as the two arguments,
a third node that performs an arithmetic operation by using the output value output from the first node as an argument,
a fourth node that performs the arithmetic operation of the second function by using an output value output from the second node and an output value output from the third node as the two arguments, and
a fifth node that receives the output value output from the first node.

5. The non-transitory computer-readable recording medium according to claim 1, wherein
the extracting includes extracting at least a portion corresponding to a third pattern that includes
a first node,
a second node that performs an arithmetic operation by using an output value output from the first node,
third nodes that are the plurality of nodes each of which performs consecutive arithmetic operations by using an output value output from the second node and can discard one of values used for the arithmetic operation performed in each of the nodes after the arithmetic operation has been performed,
a fourth node that performs an arithmetic operation by using the output value output from the second node,
a fifth node that performs an arithmetic operation by using an output value output from the third node and an output value output from the fourth node as arguments, and
a sixth node that receives an input of the output value output from the first node.

6. A conversion method implemented by a conversion apparatus, the conversion method comprising:
acquiring a predetermined original DFG and a mapping result of mapping of the DFG with respect to a CGRA that includes a plurality of arithmetic operation units, the mapping result including information that is related to allocation of an arithmetic operation to each of the arithmetic operation units and is related to a routing line between the arithmetic operation units and that has been determined so as to correspond to the predetermined original DFG;
extracting, from the predetermined original DFG, a portion corresponding to a pattern that is formed in the DFG and that has been determined in advance;
determining a conversion candidate DFG that is included in the DFG corresponding to the pattern of an extraction portion based on a location in which the extraction portion has been allocated and that is indicated in the mapping result and based on the number of transmission paths for data used between the arithmetic operation units indicated in the mapping result; and
generating a converted DFG based on the conversion candidate DFG by converting the predetermined original DFG.

7. A conversion device comprising:
a memory; and
a processor coupled to the memory and configured to:
acquire a predetermined original DFG and a mapping result of mapping of the DFG with respect to a CGRA that includes the DFG and a plurality of arithmetic operation units, the mapping result including information that is related to allocation of an arithmetic operation to each of the arithmetic operation units and is related to a routing line between the arithmetic operation units and that has been determined so as to correspond to the predetermined original DFG;
extract, from the predetermined original DFG, a portion corresponding to a pattern that is formed in the DFG and that has been determined in advance;
determine a conversion candidate DFG that is included in the DFG corresponding to the pattern of an extraction portion based on a location in which the extraction portion has been allocated and that is indicated in the mapping result and based on the number of transmission paths for data used between the arithmetic operation units indicated in the mapping result; and
generate a converted DFG based on the conversion candidate DFG by converting the predetermined original DFG.
